(19) United States
(12) Patent Application Publication
(10) Pub. No.: US 2022/0185401 A1
(43) Pub. Date: Jun. 16, 2022

(54) MOVING OBJECT AND METHOD OF CONTROLLING MOVING OBJECT

(71) Applicant: SONY GROUP CORPORATION, Tokyo (JP)

(72) Inventors: Katsufumi SUGIMOTO, Tokyo (JP); Yasuhisa KAMIKAWA, Tokyo (JP)

(73) Assignee: SONY GROUP CORPORATION, Tokyo (JP)

(21) Appl. No.: 17/604,645

(22) PCT Filed: Feb. 12, 2020
(86) PCT No.: PCT/JP2020/005230

§ 371 Date: Oct. 18, 2021

(30) Foreign Application Priority Data
May 13, 2019 (JP) 2019-090361

(51) Int. Cl. B62D 57/028

(52) U.S. Cl. CPC B62D 57/028; G05D 1/0891

(57) ABSTRACT

In a moving object including a plurality of supporting legs with casters, stability in wheel driving is improved. The moving object includes the plurality of supporting legs in which bases are mounted on a body and the casters are mounted on distal ends, a stabilizer, and a caster angle control unit. The stabilizer controls a position in contact with the ground of the caster of each of the plurality of supporting legs based on a target value of a posture of the body. The caster angle control unit controls a caster angle of each of the casters based on the target value.

### TECHNICAL FIELD

The present technology relates to a moving object. Specifically, the present technology relates to a moving object which can move with a plurality supporting legs and method of controlling the moving object.

### BACKGROUND ART

In the related art, moving objects that operate a plurality of supporting legs and walk to be able to pass over obstacles, steps, and the like are used for various purposes such as carrying luggage and providing security or entertainment. Such moving objects are also called robots. In general, in movement when moving objects that operate supporting legs walk, a movement speed is slower than in wheel traveling. Accordingly, a moving object in which casters are mounted on the distal ends of supporting legs to be able to perform wheel driving in addition to walking has been proposed (for example, see PTL 1).

### CITATION LIST

### Patent Literature

[PTL 1]

JP 2009-154256A

### SUMMARY

### Technical Problem

The above-described moving object transitions to a driving mode in which wheel driving is performed in movement on a flat ground or the like on which wheel driving is easy and transitions to a walking mode in which walking is performed in movement on an irregular ground or the like on which the wheel driving is difficult, and thus it is possible to achieve compatibility between an improvement in a movement speed and an improvement in irregular ground traveling. However, the moving object changes positions of the supporting legs in contact with the ground to avoid an obstacle or a stepped difference on a road surface in the driving mode, and consequently alters its posture in some cases. In these cases, however, the moving object can restore its posture by temporarily separating other supporting legs from the ground surface and stepping down to stabilize a posture. However, stepping down with supporting legs during driving involves a risk of overturning. When a driving speed is decreased temporarily, the risk of overturning in stepping down with the supporting legs can be reduced. However, since an average speed is decreased, this is not preferable. Thus, in the above-described moving object, it is difficult to improve stability when wheel driving is performed.

The present technology has been devised in view of such circumstances and an objective of the present technology is to improve stability in wheel driving of a moving object that includes a plurality of supporting legs with casters.

### Solution to Problem

The present technology has been devised to solve the above-described problems and a first aspect is a moving object including: a plurality of supporting legs in which bases are mounted on a body and casters are mounted on distal ends; a stabilizer configured to control a position in contact with the ground of the caster of each of the plurality of supporting legs based on a target value of a posture of the body; and a caster angle control unit configured to control a caster angle of each of the casters based on the target value, and is a method of controlling the moving object. Thus, it is possible to obtain the operational effect of controlling the caster angle based on the target value of the posture.

According to the first aspect, in transition to a driving mode in which the moving object performs wheel driving, the caster angle control unit may obtain a ratio of a height from a road surface to the base to a caster trail of the caster and a new target value based on a mechanical impedance and torsional rigidity of each of the plurality of supporting legs. Thus, in the driving mode, it is possible to obtain the operational effect of obtaining the ratio of the height to the caster trail and the new target value.

According to the first aspect, in transition to a walking mode in which the moving object may perform walking, the caster angle control unit may obtain a mechanical impedance based on torsional rigidity of each of the plurality of supporting legs, the target value, a height from a road surface to the base, and a caster trail of the caster. Thus, it is possible to obtain the operational effect of obtaining the mechanical impedance in the walking mode.

According to the first aspect, the moving object may further include a plurality of lifts configured to support a luggage bed; and a lift control unit configured to control the plurality of lifts based on the target value. Thus, it is possible to obtain the operational effect of controlling the lift based on the target value.

According to the first aspect, the body may include a front body, a rear body, and a connection unit connecting the front body to the rear body. Thus, it is possible to obtain the operational effect of controlling the postures of the front body and the rear body independently.

According to the first aspect, the caster may include a wheel unit and a damper stretched in a direction perpendicular to the road surface. Thus, it is possible to obtain the operational effect of increasing the caster angle when a weight is applied.

According to the first aspect, each of the plurality of supporting legs may include a first articulation provided in the base, a second articulation, and a third articulation provided in the distal end. The first articulation may be a biaxial articulation. Thus, it is possible to obtain the operational effect of enlarging the movable range of the supporting legs.

According to the first aspect, the plurality of supporting legs may include a pair of front supporting legs and a pair of rear supporting legs. Thus, it is possible to obtain the operational effect of controlling the caster angles of the four legs.

According to the first aspect, a mounting angle of the base of each of the pair of front supporting legs may be different from a mounting angle of the base of each of the pair of rear supporting legs. Thus, it is possible to obtain the operational effect of causing the caster angles in the initial states to differ between the front and rear sides.

According to the first aspect, the number of plurality of supporting legs may be two. Thus, it is possible to obtain the operational effect of controlling the caster angles of the two legs.

### BRIEF DESCRIPTION OF DRAWINGS

FIG. 1 is an outer appearance view of a moving object according to a first embodiment of the present technology.

FIG. 2 is a block diagram illustrating an exemplary configuration of the moving object according to the first embodiment of the present technology.

FIG. 3 is a block diagram illustrating an exemplary configuration of a caster angle control unit according to the first embodiment of the present technology.

FIG. 4 is a side view illustrating an exemplary configuration of a supporting leg according to the first embodiment of the present technology.

FIG. 5 is a diagram illustrating rotational axes of first and third articulations according to the first embodiment of the present technology.

FIG. 6 is a block diagram illustrating an exemplary configuration of a walking mode control unit according to the first embodiment of the present technology.

FIG. 7 is a block diagram illustrating an exemplary configuration of a driving mode control unit according to the first embodiment of the present technology.

FIG. 8 is a side view illustrating an example of a mounting angle according to the first embodiment of the present technology.

FIG. 9 is a diagram illustrating a process in driving on a sloping surface according to the first embodiment of the present technology.

FIG. 10 is a diagram illustrating an advantageous effect when a caster angle is given according to the first embodiment of the present technology.

FIG. 11 is a diagram illustrating control of a control unit according to the first embodiment of the present technology.

FIG. 12 is a diagram illustrating control of a stabilizer and a caster angle control unit according to the first embodiment of the present technology.

FIG. 13 is a flowchart illustrating an example of an operation of the control unit according to the first embodiment of the present technology.

FIG. 14 is a side view illustrating an exemplary configuration of a moving object according to a second embodiment of the present technology.

FIG. 15 is a block diagram illustrating an exemplary configuration of the moving object according to the second embodiment of the present technology.

FIG. 16 is a diagram illustrating a lift control method according to the second embodiment of the present technology.

FIG. 17 is a side view illustrating an exemplary configuration of a moving object according to a third embodiment of the present technology.

FIG. 18 is a side view illustrating an exemplary configuration of a moving object according to a fourth embodiment of the present technology.

FIG. 19 is a side view illustrating an exemplary configuration of a moving object according to a fifth embodiment of the present technology.

FIG. 20 is a cross-sectional view illustrating an exemplary configuration of a caster according to a sixth embodiment of the present technology.

FIG. 21 is a side view illustrating an exemplary configuration of a moving object according to a seventh embodiment of the present technology.

FIG. 22 is a side view illustrating an exemplary configuration of a moving object according to an eighth embodiment of the present technology.

### DESCRIPTION OF EMBODIMENTS

Hereinafter, modes for carrying out the present technology (hereinafter referred to as embodiments) will be described. The description will be made in the following order.

1. First embodiment (example in which caster angle is controlled)

2. Second embodiment (example in which lift and caster angles are controlled)

3. Third embodiment (example in which body is separated into two pieces and caster angle is controlled)

4. Fourth embodiment (example in which body is separated into two pieces and lift and caster angle are controlled)

5. Fifth embodiment (example in which caster angle is controlled by setting the front mounting angle to be different from that of the rear)

6. Sixth embodiment (example in which damper is provided and caster angle is controlled)

7. Seventh embodiment (example in which biaxial articulation is provided and caster angle is controlled)

8. Eighth embodiment (example in which caster angle of each of two legs is controlled)

9. Example of application to moving objects

### 1. First Embodiment

[Exemplary Configuration of Moving Object]

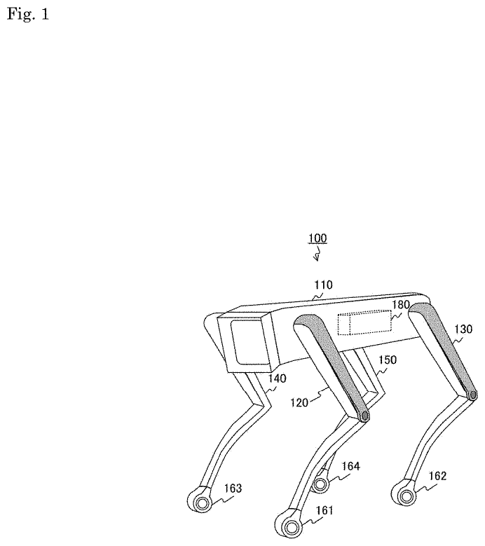

FIG. 1 illustrates an example of an outer appearance of a moving object 100 according to a first embodiment of the present technology. The moving object 100 is an unmanned robot used for various use purposes such as carrying luggage and providing security or entertainment and includes a body 110 and a plurality of supporting legs. For example, four supporting legs 120, 130, 140, and 150 are provided in the moving object 100.

The body 110 is an elongated part, and a control unit 180 that controls the four supporting legs (the support leg 120 and the like) is provided inside.

Bases of the supporting legs 120, 130, 140, and 150 are mounted on the body 110 and casters 161 to 164 are mounted on the distal ends. A member mounted on the distal end of an arm or a leg of a robot in this way is also called an end effector.

When a direction from one side to the other side of both ends of the elongated body 110 is set as the front, the supporting legs 120 and 140 are mounted on the front side and the supporting legs 130 and 150 are mounted on the rear side. The supporting legs 120 and 140 are examples of front supporting legs described in the claims and the supporting legs 130 and 150 are examples of rear supporting legs described in the claims.

Each of the supporting legs 120 includes a plurality of articulations and actuators driving the articulations. The number of articulations and articulation axes will be described later.

The moving object 100 includes various sensors (not illustrated) such as a sensor that detects an angle of the actuator, an image sensor that images a road surface, an acceleration sensor, and a gyro sensor. The acceleration sensor and the gyro sensor are provided in, for example, an inertial measurement unit (IMU).

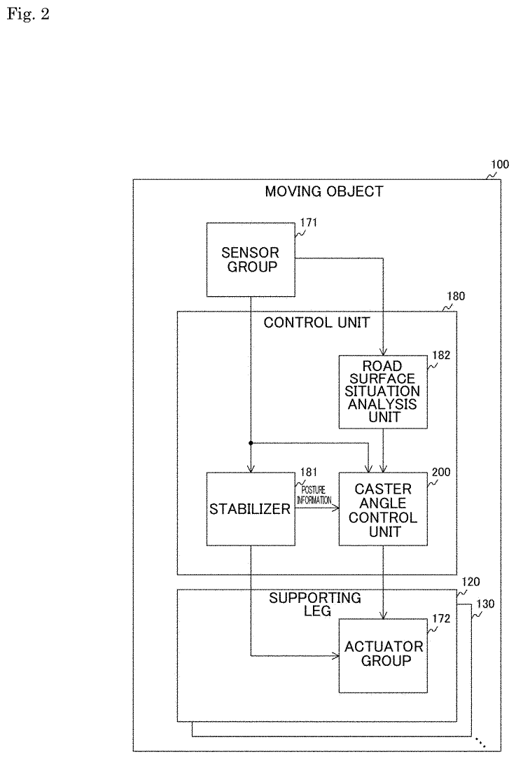

FIG. 2 is a block diagram illustrating an exemplary configuration of the moving object 100 according to the first embodiment of the present technology. The moving object 100 includes a sensor group 171, the control unit 180, and four supporting legs (the supporting legs 120 and the like). In each of the supporting legs, an actuator group 172 is provided. The control unit 180 includes a stabilizer 181, a road surface situation analysis unit 182, and a caster angle control unit 200.

The sensor group 171 is a sensor group that detects an internal or external situation of the moving object 100. For example, a sensor that detects an angle of the actuator, an image sensor that images a road surface, an acceleration sensor, a gyro sensor, and the like are provided as the sensor group 171. The sensor group 171 supplies detected data to the control unit 180.

The actuator group 172 is an actuator group that operates an articulation of each of the supporting leg 120 and the like.

The stabilizer 181 performs stabilization control (for example, ZMP control) for avoiding overturning. When ZMP control is performed, the stabilizer 181 controls a grounding position of leg tips (the casters 161 to 164) of the supporting leg 120 and the like based on a zero moment point (ZMP) and a target value of a posture of the body 110. Here, the ZMP means an operational center of gravity of a vertical floor reaction force and posture control performed using the ZMP is referred to as ZMP control. The posture of the body 110 is indicated by, for example, a pitch angle of the body 110.

The stabilizer 181 acquires a present value of a present posture (the pitch angle or the like) of the body 110 from the IMU or the like. The stabilizer 181 calculates a position at which a present lifted leg is subsequently grounded and a force which arises in the perpendicular direction of the presently grounded supporting leg from a difference between the present value and a target value of a posture at which the ZMP is located within a supporting polygon. Here, the lifted leg is a supporting leg of which the leg tip is away from a road surface and the supporting polygon is a polygon drawn by the leg tip. The stabilizer 181 inputs the calculated value into a reverse dynamic solver along with the present grounding position of the leg tip and a mechanical impedance of the leg tip. Here, the reverse dynamic solver is a program that calculates a torque which is given to an articulation when an angle, an angular velocity, and an angular acceleration of the articulation are input.

Then, the stabilizer 181 outputs a value of the torque calculated from the target value of the posture as a target value of torque to the corresponding actuator in the actuator group 172. The stabilizer 181 supplies posture information indicating the target value of the posture to the caster angle control unit 200. The stabilizer 181 is an example of a stabilizer described in the claims.

The road surface situation analysis unit 182 analyzes a situation of a road surface using data from the image sensor or the like. The road surface situation analysis unit 182 generates a mode signal indicating one of a walking mode and a driving mode based on an analysis result and outputs the mode signal to the caster angle control unit 200. Here, the walking mode is a mode in which the moving object 100 moves by walking and the driving mode is a mode in which the moving object 100 moves by wheel driving. For example, when a road surface is flat and there are almost no obstacles, the driving mode is preferentially set. When the road surface is uneven or there are obstacles, the walking mode is preferentially set.

The caster angle control unit 200 controls caster angles of the casters 161 to 164 based on the posture information. The caster angle control unit 200 calculates a target value of torque based on control content and outputs the target value to the corresponding actuator in the actuator group 172.

The moving object 100 switches the mode between the walking mode and the driving mode based on an analysis result of the road surface situation, but the present technology is not limited to this configuration. A communication interface that communicates with the outside of the moving object 100 may be further included to switch the mode in accordance with a command from the outside.

[Exemplary Configuration of Caster Angle Control Unit]

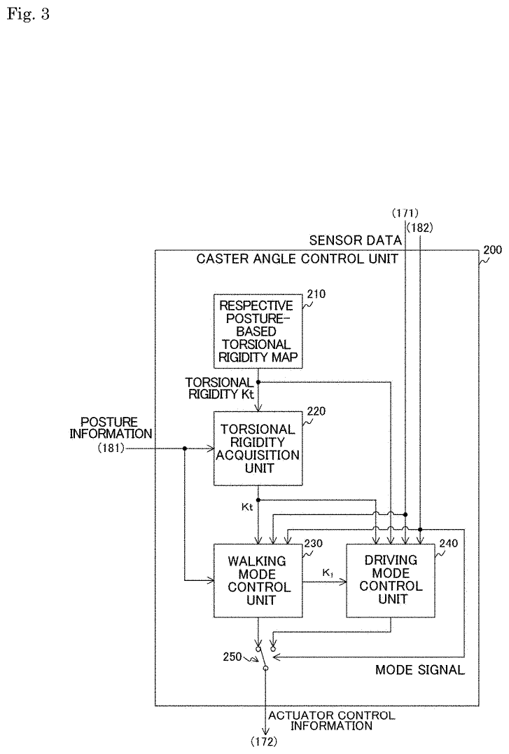

FIG. 3 is a block diagram illustrating an exemplary configuration of the caster angle control unit 200 according to the first embodiment of the present invention. The caster angle control unit 200 includes a respective posture-based torsional rigidity map 210, a torsional rigidity acquisition unit 220, a walking mode control unit 230, a driving mode control unit 240, and a selection unit 250.

The respective posture-based torsional rigidity map 210 stores respective torsional rigidity of the supporting leg 120 or the like for each representative posture of the body 110.

The torsional rigidity acquisition unit 220 obtains the torsional rigidity of each supporting leg based on the posture information from the stabilizer 181. The torsional rigidity acquisition unit 220 reads the torsional rigidity corresponding to the posture indicated by the posture information from the respective posture-based torsional rigidity map 210. When the torsional rigidity corresponding to the posture is not stored, the torsional rigidity acquisition unit 220 obtains the torsional rigidity through linear interpolation. The torsional rigidity acquisition unit 220 supplies the obtained torsional rigidity Kₜ to the walking mode control unit 230 and the driving mode control unit 240.

When the mode signal from the road surface situation analysis unit 182 indicates the walking mode, the walking mode control unit 230 calculates a mechanical impedance K₁ of an articulation satisfying a given condition. The walking mode control unit 230 generates actuator control information that supports an angle or torque of the actuator based on a calculation result and supplies the actuator control information to the selection unit 250. The walking mode control unit 230 supplies the calculated mechanical impedance K₁ to the driving mode control unit 240.

When the mode signal indicates the driving mode, the driving mode control unit 240 calculates a parameter related to the caster angle. The content of the calculated parameter will be described later. The driving mode control unit 240 generates actuator control information based on the calculation result and supplies the actuator control information to the selection unit 250.

The selection unit 250 selects the actuator control information of one of the walking mode control unit 230 and the driving mode control unit 240 in accordance with the mode signal and supplies the actuator control information to the actuator group 172. In the case of the walking mode, the output of the walking mode control unit 230 is selected. In the case of the driving mode, the output of the driving mode control unit 240 is selected.

[Exemplary Configuration of Supporting Leg]

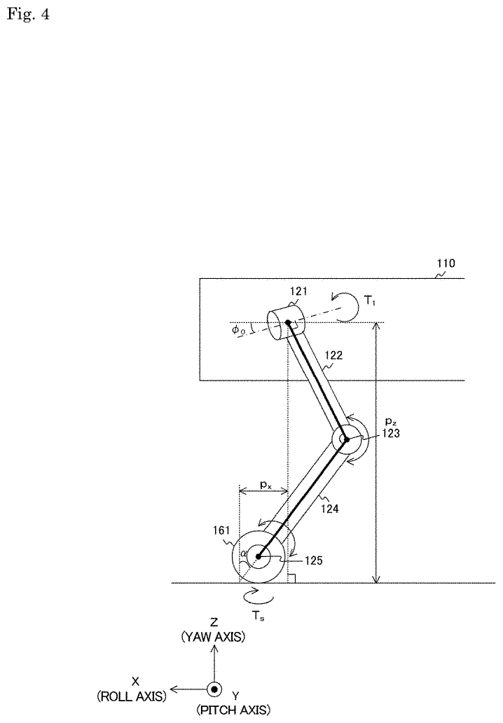

FIG. 4 is a side view illustrating an exemplary configuration of the supporting leg 120 according to the first embodiment of the present technology. The supporting leg 120 includes a first articulation 121, a link 122, a second articulation 123, a link 124, and a third articulation 125.

Hereinafter, an axis parallel to a movement direction of the moving object 100 is referred to as the “X axis” and a direction perpendicular to a road surface is referred to as the “Z axis.” An axis perpendicular to the X and Z axes is referred to as a “Z axis.” When the articulation is rotated around the axes, the X axis corresponds to a roll axis, the Y axis corresponds to a pitch axis, and the Z axis corresponds to a yaw axis.

The first articulation 121 is an articulation provided in the base of the supporting leg 120 and corresponds to a shoulder joint when the supporting leg 120 is compared to a human arm. When a pitch angle formed between a straight line perpendicular to the axis of the link 122 and a straight line parallel to the longitudinal direction of the body 110 is set as a mounting angle, the first articulation 121 is mounted so that the mounting angle becomes a fixed value φ₀. The actuator rotates the first articulation 121 around a predetermined axis in which an angle to the roll axis is φ₀. Strictly speaking, the rotational axis of the first articulation 121 does not correspond to the roll axis when φ₀ is not “0” degrees. However, to facilitate description, the rotational axis of the first articulation 121 is treated as the roll axis below even in this case.

The actuator rotates the second articulation 123 around the pitch axis and corresponds to a joint of an arm when the supporting leg 120 is compared to a human arm. The actuator rotates the third articulation 125 around the pitch axis and the yaw axis and corresponds to a wrist joint when the supporting leg 120 is compared to a human arm.

The link 122 is a member that connects the first articulation 121 to the second articulation 123. The link 124 is a member that connects the second articulation 123 to the third articulation 125.

A configuration of each of the supporting legs 130, 140, and 150 is the same as that of the supporting leg 120.

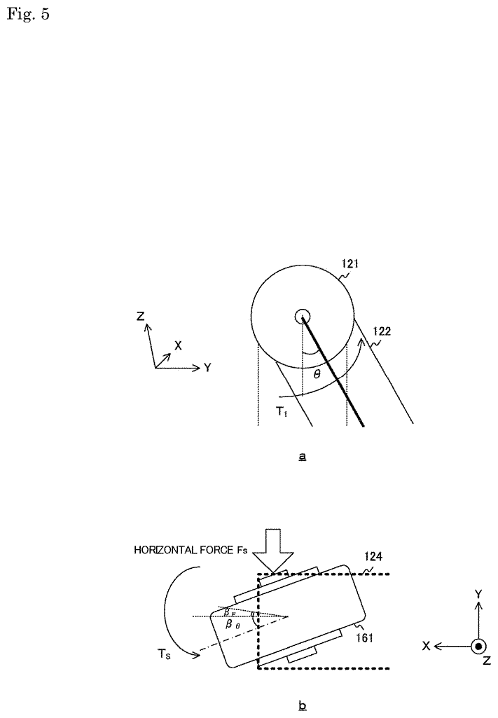

FIG. 5 is a diagram illustrating rotational axes of the first articulation 121 and the third articulation 125 according to the first embodiment of the present technology. In the drawing, a is a view of the first articulation 121 viewed from the rotational axis (that is, the roll axis) of the first articulation 121. In the drawing, b is a top view illustrating the caster 161 viewed from the yaw axis among the rotational axes of the third articulation 125.

As described above, the stabilizer 181 performs stabilization control (ZMP control or the like) to avoid overturning. However, the control may result in widening (or narrowing) of the leg tip of the support leg compared with an initial state. During driving, disturbance may be applied to the caster 161 and the like and the position may be slightly deviated in some cases. When the moving object 100 is assumed to be driving straight ahead, a force is applied to the caster 161 and the like in a direction perpendicular to the side surface (in other words, a horizontal direction). This force is referred to as a “horizontal force” below. Here, a condition is conceivable in which a direction or a posture of the caster 161 is restored without divergence or vibration and a specific direction or posture converges when the horizontal force arises during straight ahead driving.

First, a moment (that is, torque) that is applied around the roll axis of the first articulation 121, as exemplified in a of the drawing, and a moment around the yaw axis of the caster 161, as exemplified in b of the drawing are conceivable. Torque T₁ of the former is balanced with a roll axis component of a horizontal force F_{S} applied in the side surface direction (that is, the Y direction) of the caster 161, and thus the following expression is established.

T₁=p_{z}cos(φ)F_{S}=K₁Δθ Expression 1

In the above expression, a unit of the torque T₁ is, for example, a newton meter (Nm). Here, p_{z} is a height from the road surface to the base of the supporting leg 120 and its unit is, for example, a meter (m). cos( ) indicates a sine function. φ is an angle formed between the longitudinal direction of the body 110 and the road surface (in other words, a pitch angle). Δθ is a minute change in the yaw angle of the caster 161. Units of φ and Δθ are, for example, a radian (rad). A unit of the horizontal force Fs is, for example, a newton (N).

When Kₜ is torsional rigidity of the supporting leg 120 and the yaw angle of the caster 161 is changed by β_{F} due to a change in the posture by the horizontal force F_{S}, the following expression is established.

Kₜβ_{F}=F_{S}pₓ Expression 2

In the above expression, a unit of the torsional rigidity Kₜ is, for example, a newton per meter (N/m). A unit of the angle β_{F} is, for example, a radian (rad).

When β₀ is a change amount around the yaw axis of the caster 161 at the time of a change in the roll angle of the first articulation 121 by θ, the following expression is established due to a geometric constraint.

tan β_{θ}=sinθ tan φ Expression 3

In the above expression, tan is a tangent function and sin is a cosine function. Units of the angles β_{θ} and θ are, for example, a radian (rad).

Here, when β is an angle of sideslip around the yaw axis occurring in the caster 161, the following expression is established.

β=β_{θ}−β_{F} Expression 4

When Expressions 2 and 3 are substituted into Expression 4, the following expression is obtained.

β=a tan(sin θ tan φ)−F_{S}pₓ/Kₜ Expression 5

In the above expression, a tan( ) is an arctangent function. Here, pₓ is a distance on the X axis between a point at which a straight line along the link 124 intersects the road surface and the base and its unit is, for example, a meter (m). pₓ is generally called a caster trail.

When the angle θ is Δθ, Expression 5 is replaced with the following expression.

β=a tan(sin Δθ tan φ)−F_{S}pₓ/Kₜ Expression 6

When Expression 1 is substituted into Expression 6, the following expression is obtained.

β=a tan{tan φ sin(F_{S}p_{z} cos φ/K₁)}−(F_{Sxt}) Expression 7

When the angle φ is a sufficiently small value, Expression 7 can be approximated to the following expression.

$$β = ( {F}_{S} {p}_{z} φ \text{/} {K}_{1} ) \cdot ( {F}_{S} {p}_{x} \text{/} {K}_{t} ) \\ = \{ ( {p}_{z} φ \text{/} {K}_{1} ) \cdot {p}_{x} \text{/} {K}_{t} \} {F}_{S} \qquad Expression 8$$

For the horizontal force F_{S}, a direction from the outside to the inside of the body 110 is a forward direction. For the angle β, polarity of a change amount from the inside to the outside of the body 110 is positive. In this case, because of the property of the horizontal force F_{S}, when the following condition expression regarding the right side of Expression 8 is established, a restoration moment arises and the caster 161 remains stabilized without sideslip.

(p_{z}φ/K₁)−pₓ/Kₜ≥0 Expression 9

When Expression 9 is modified, the following expression is obtained.

K₁≤{(p_{z}φ)/pₓ}Kₜ Expression 10

A case is conceivable in which a height p_{z} of the front supporting legs 120 and 140 and the caster trail pₓ are controlled such that they have the same value. During the control of the front supporting legs, the height p_{z} of the rear supporting legs 130 and 150 and the caster trail pₓ are controlled such that they have a fixed value. In this case, from a movable range or an extendable range of the supporting legs 120 and 140, the following expression is established.

φ=f(p_{z}/pₓ) Expression 11

In the above expression, f( ) is a predetermined function indicating a relation in which the smaller a ratio p_{z}/pₓ is, the larger the pitch angle φ is.

When the height p_{z} of the rear supporting legs 130 and 150 and the caster trail pₓ are controlled, the height or the like of the front supporting legs may be fixed during the control.

In the walking mode, the walking mode control unit 230 substitutes the torsional rigidity Kₜ and the ratio of the present height p_{z} to the caster trail px into Expression 10 to calculate the maximum mechanical impedance K₁ satisfying Expression 10. The walking mode control unit 230 controls the torque or the angle of each articulation based on the calculated value.

In the driving mode, on the other hand, the driving mode control unit 240 substitutes the present mechanical impedance K₁, the torsional rigidity Kₜ, and Expression 11 into Expression 10 to calculate the minimum p_{z}/pₓ satisfying Expression 10 and controls the torque or the like of each articulation so that this value is obtained. The larger the calculated p_{z}/pₓ is, the larger the caster angle α of the caster 161 is. Here, the caster angle α is an angle formed between a straight line parallel to the link 124 and a perpendicular line perpendicular to the road surface. Setting the caster angle a to be greater than “0” degrees is generally expressed as “giving the caster angle.”

For a posture (the yaw angle) of the caster, it is assumed that the moving object 100 goes straight. However, control may be performed such that stabilization is achieved at a specific posture (the yaw angle) assuming a turning time or the like.

For a posture (a pitch angle or the like of the articulation) of the supporting leg of which the caster is fixed, it is also assumed that the moving object goes straight. However, design may come up with in consideration of any posture at the time of turning or the like. In this case, the calculation may be performed sequentially in accordance with a posture at the time of changeover, turning, or the like.

In the above-described calculation, the mechanical impedance stabilized in the wheel driving is obtained by uniaxial impedance control. However, a structure such as a closed link or the Stewart platform may be used for realization by impedance control to a virtual axis expressed as a result of two or more axes. By setting the torsional rigidity of the supporting legs to be variable and varying the torsional rigidity, the control of the driving mode may be realized.

[Exemplary Configuration of Walking Mode Control Unit]

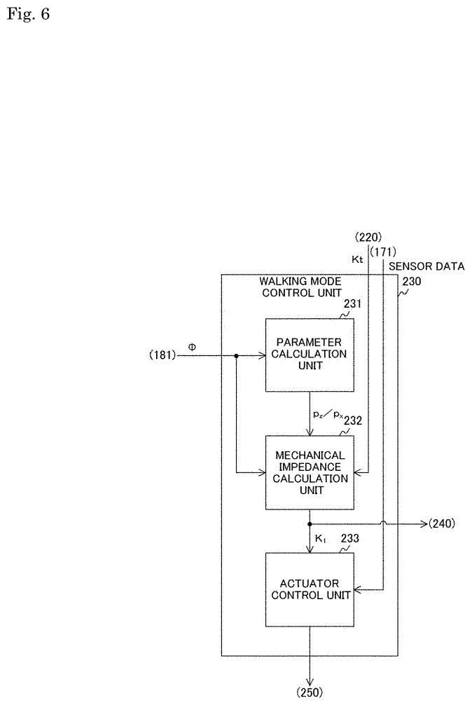

FIG. 6 is a block diagram illustrating an exemplary configuration of the walking mode control unit 230 according to the first embodiment of the present technology. The walking mode control unit 230 includes a parameter calculation unit 231, a mechanical impedance calculation unit 232, and an actuator control unit 233.

The parameter calculation unit 231 calculates the ratio p_{z}/pₓ in accordance with the posture (the pitch angle φ). When the posture is input from the stabilizer 181, the parameter calculation unit 231 calculates the ratio p_{z}/pₓ using Expression 11 and supplies the ratio p_{z}/pₓ to the mechanical impedance calculation unit 232.

The mechanical impedance calculation unit 232 calculates the mechanical impedance K₁ of the articulation. When the posture is input from the stabilizer 181, the mechanical impedance calculation unit 232 inputs the posture, the torsional rigidity Kₜ from the torsional rigidity acquisition unit 220, and the ratio p_{z}/pₓ from the parameter calculation unit 231 into Expression 11. Then, the mechanical impedance calculation unit 232 calculates the maximum mechanical impedance K₁ satisfying Expression 11. The mechanical impedance calculation unit 232 calculates the mechanical impedance K₁ at a given period in the driving mode and supplies the calculated value to the actuator control unit 233 and the driving mode control unit 240.

The actuator control unit 233 controls the torque or the angle of the articulation based on the mechanical impedance K₁. The actuator control unit 233 retains a mechanical impedance K₀ in which the walking operation is assumed as a current value in advance. When the mechanical impedance K₁ is newly calculated, the actuator control unit 233 controls torque or the like of the articulation using the actuator such that an impedance gain K₁/K₀ at an assumed speed range is maintained as a given value.

[Exemplary Configuration of Driving Mode Control Unit]

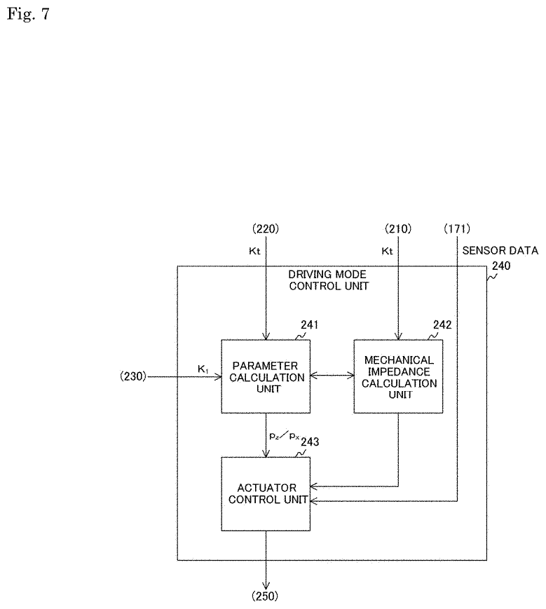

FIG. 7 is a block diagram illustrating an exemplary configuration of the driving mode control unit 240 according to the first embodiment of the present technology. The driving mode control unit 240 includes a parameter calculation unit 241, a mechanical impedance calculation unit 242, and an actuator control unit 243.

The parameter calculation unit 241 calculates the ratio p_{z}/pₓ. In transitions to the driving mode, the parameter calculation unit 241 substitutes the mechanical impedance K₁ from the walking mode control unit 230, the torsional rigidity Kₜ from the torsional rigidity acquisition unit 220, and Expression 11 into Expression 10 to calculate the minimum ratio p_{z}/pₓ satisfying Expression 10. The parameter calculation unit 241 calculates a new posture (the pitch angle φ) corresponding to the calculated ratio p_{z}/pₓ using Expression 11. The parameter calculation unit 241 supplies the calculated value to the mechanical impedance calculation unit 242 and the actuator control unit 243.

The mechanical impedance calculation unit 242 calculates the mechanical impedance K₁ at a given period in the driving mode. The mechanical impedance calculation unit 242 acquires a new torsional rigidity Kₜ corresponding to the pitch angle φ from the parameter calculation unit 241. For example, the torsional rigidity Kt is acquired through linear interpolation or reading from the respective posture-based torsional rigidity map 210.

Then, the mechanical impedance calculation unit 242 substitutes the acquired torsional rigidity Kₜ, the ratio p_{z}/pₓ from the parameter calculation unit 241, and the pitch angle φ into Expression 10 to newly calculate the maximum mechanical impedance K₁ satisfying Expression 10. The mechanical impedance calculation unit 242 supplies the calculated values to the parameter calculation unit 241 and the actuator control unit 243.

The parameter calculation unit 241 monitors the mechanical impedance K₁ from the mechanical impedance calculation unit 242. When the values deviate from ranges decided in a design stage, the parameter calculation unit 241 recalculates the ratio p_{z}/pₓ and the like and supplies the recalculated values to the mechanical impedance calculation unit 242 and the actuator control unit 243.

The actuator control unit 243 controls the torque or the angle of the articulation based on the values calculated by the parameter calculation unit 241 or the mechanical impedance calculation unit 242.

As described with reference to FIGS. 1 to 7, the bases of the supporting legs 120, 130, 140, and 150 are mounted on the body 110 and the casters 161 to 164 are mounted on the distal ends. The stabilizer 181 controls the grounding positions of the casters 161 to 164 based on the ZMP and the target value of the posture of the body 110. The caster angle control unit 200 controls the caster angles of the casters 161 to 164 based on the target value.

The walking mode control unit 230 in the caster angle control unit 200 obtains the mechanical impedance K₁ of the articulation based on the torsional rigidity Kₜ, the target value of the posture (the pitch angle φ or the like), and the ratio p_{z}/pₓ in the transition to the walking mode.

In the transition to the driving mode, the driving mode control unit 240 in the caster angle control unit 200 obtains the ratio p_{z}/pₓ and a target value of a new posture based on the mechanical impedance K₁ and the torsional rigidity Kₜ.

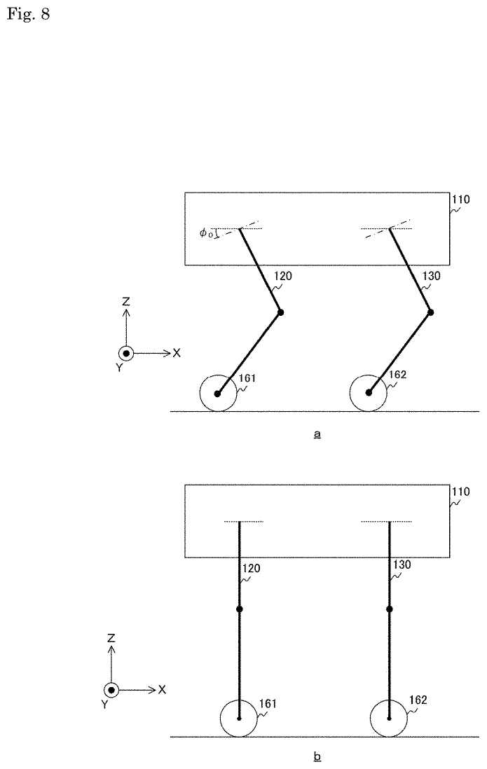

FIG. 8 is a side view illustrating an example of a mounting angle according to the first embodiment of the present technology. In the drawing, a is a side view of the moving object 100 on which the supporting legs are mounted at a mounting angle φ₀ less than 90 degrees. In the drawing, b is a side view of the moving object 100 on which the supporting legs are mounted at the mounting angle φ₀ of 90 degrees.

In the drawing, as exemplified in a, when the mounting angle φ₀ is less than 90 degrees, the caster angle α is greater than “0” degrees in an initial state. That is, the caster angle is given in this state.

In the drawing, on the other hand, as exemplified in b, when the mounting angle φ₀ is 90 degrees, the caster angle α is “0” degrees in the initial state. Here, in this case, the caster angle can also be given under the control of the control unit 180.

In general, as the caster angle α is larger, driving stability in straight movement of the moving object is improved, but a minimum turning radius increases. An appropriate mounting angle φ₀ is determined in consideration of the characteristics.

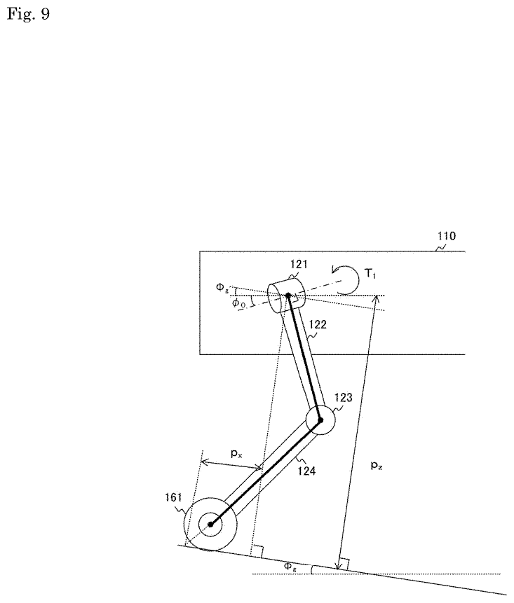

FIG. 9 is a diagram illustrating a process in driving on a sloping surface according to the first embodiment of the present technology. In the drawing, an angle formed between a plane perpendicular to the gravity and a slope plane around the Y axis (that is, the pitch axis) is referred to as a gradient φ_{g}. In driving on such a slope plane, the control unit 180 obtains the gradient φ_{g} using an IMU or the like and adds the gradient φ_{g} to the posture (pitch angle φ) of the body 110. Then, the control unit 180 calculates the ratio p_{z}/pₓ or the mechanical impedance K₁ using the added value as φ of Expression 11. The control unit 180 can also obtain the gradient φ_{g} using a magnetic sensor, a Global Positioning System (GPS) sensor, or the like.

A sloping surface with the gradient around the Y axis is assumed, but the moving object 100 can also drive on the sloping surface with a gradient around the X axis. In this case, when the width of the caster in the right and left directions is sufficiently narrow as in a two-wheeled vehicle, it is not necessary to consider a change in the grounding surface. The control unit 180 controls the left and right supporting legs independently so that the moving object 100 can operate stably.

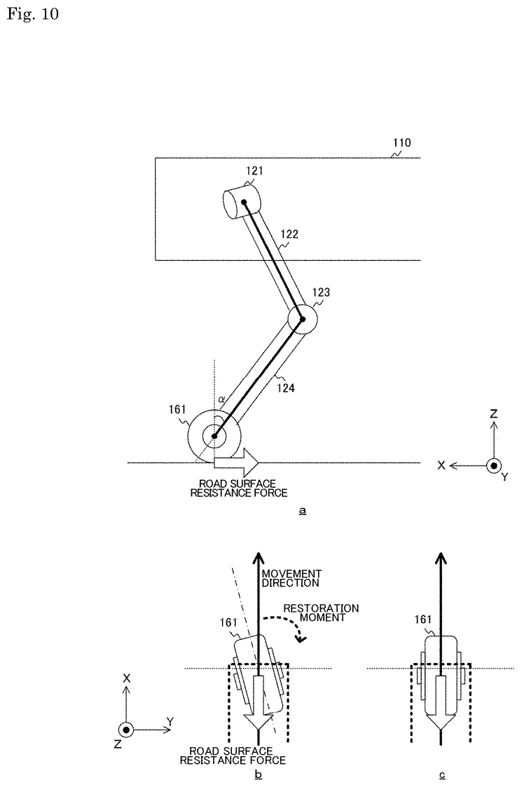

FIG. 10 is a diagram illustrating an advantageous effect when a caster angle is given according to the first embodiment of the present technology. In the drawing, a is a side view illustrating a road surface resistance force applied when the caster angle α is given. In the drawing, b is a top view illustrating the caster 161 to describe a restoration moment for the road surface resistance force. In the drawing, c is a top view illustrating the caster 161 in a stable state due to the restoration moment.

In the drawing, as exemplified in a, the control unit 180 gives the caster angle a to the caster 161 by controlling the actuator in the driving mode. In this case, when the caster 161 rubs the road surface, a road surface resistance force arises on the grounding surface in an opposite direction to a movement direction. The larger the caster angle α is, the larger the road surface resistance force is. An outlined arrow in the drawing indicates the road surface resistance force.

As a result of stabilization control (ZMP control or the like), as exemplified in b of the drawing, the horizontal force is applied to the caster 161 and the caster 161 is oriented in a different direction from the movement direction. Here, the direction of the caster 161 is a direction indicated by a straight line parallel to the road surface (that is, indicated by a one-dot chain line in the drawing) and perpendicular to an axle of the caster 161. When the road surface resistance force arises, the above-described restoration moment is applied in an opposite direction to the direction in which the caster 161 is oriented. The larger the road surface resistance force is, the larger the restoration moment is. In the drawing, a thick dotted line indicates the restoration moment.

When the restoration moment is sufficiently large, as exemplified in c of the drawing, the direction of the caster 161 is the same as the movement direction due to the restoration moment, and thus sideslip of the caster 161 is prevented.

In this way, when the horizontal force is applied, the moving object 100 can also apply the restoration moment in accordance with the road surface resistance force by increasing the caster angle a and generating the road surface resistance force. Due to the restoration moment, the direction of the caster 161 returns to the movement direction, and thus sideslip is prevented.

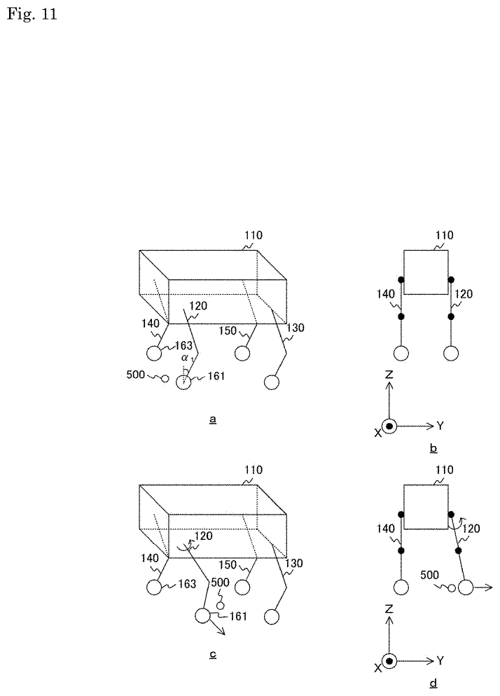

FIG. 11 is a diagram illustrating control of the control unit 180 according to the first embodiment of the present technology. In the drawing, a is an outer appearance view of an example of a state of the moving object 100 in the driving mode. In the drawing, b is a front view of the moving object 100 in the state of a of the drawing when viewed from the front. In the drawing, c is an outer appearance view illustrating an example of a state in which the supporting leg 120 is opened. In the drawing, d is a front view illustrating the moving object 100 in the state of c of the drawing when viewed from the front.

In the driving mode, as exemplified in a and b of the drawing, it is assumed that a pitch angle of the body 110 is “0” degrees and a caster angle is α₁. While the moving object 100 is driving, for example, the moving object 100 is assumed to detect existence of an obstacle 500 in the front, for example, by analyzing image data captured by an image sensor.

In this case, for the moving object to avoid overturning, for example, as exemplified in c and d of the drawing, the control unit 180 may open the leg tip by controlling the supporting leg 120. Apart from the obstacle 500, to avoid a stepped difference, the moving object 100 opens its supporting legs in some cases. Alternatively, a supporting leg may collide with an obstacle or a stepped difference during driving and the supporting leg may be opened in some cases.

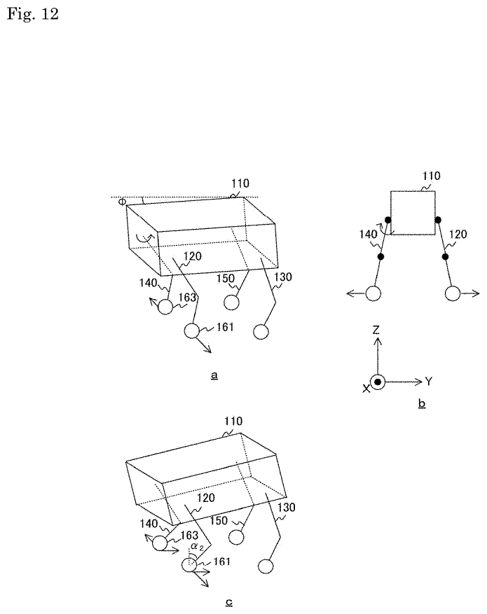

FIG. 12 is a diagram illustrating control of the stabilizer 181 and the caster angle control unit 200 according to the first embodiment of the present technology. In the drawing, a is an outer appearance view illustrating control of the stabilizer 181. In the drawing, b is a front view of the moving object 100 in the state of a of the drawing when viewed from the front. In the drawing, c is an outer appearance view illustrating control of the caster angle control unit 200.

When the control unit 180 opens the leg tip of the supporting leg 120, as exemplified in a and b of the drawing, to stabilize the moving object 100, the stabilizer 181 opens the leg tip of the supporting leg 140 to the same degree as the supporting leg 120. When the leg tips of the supporting legs 120 and 140 are opened, the pitch angle φ of the body 110 increases. In this case, the horizontal force is applied to the leg tips (the casters) of the supporting legs 120 and 140 toward the outside In the drawing, an arrow indicated by a solid line indicates the horizontal force. When the horizontal force is large, the casters are inclined in a direction different from the movement direction, and thus there is concern of the leg tips being gradually opened.

At this time, the caster angle control unit 200 increases the caster angles as the pitch angle φ is larger by controlling the actuators, as exemplified in c of the drawing. For example, the caster angle is controlled to α₂ which is greater than α₁ which is a value before the leg tips are opened.

The larger the caster angle is, the larger a road surface resistance force applied to the casters is. The direction of the casters returns to the movement direction due to the restoration moment in accordance with the road surface resistance force, and thus the leg tips are inhibited from being opened further.

Here, a comparative example in which the caster angle control unit 200 is not provided in the moving object 100 will be assumed. In the comparative example, as exemplified in a of the drawing, when the leg tips are opened, the stabilizer can also cause the supporting legs to temporarily separates from the ground surface and step down to stabilize the posture through the stabilization control (ZMP control), so that the posture of the body 110 can be restored. However, stepping down with the legs during driving involves a risk of overturning. When a driving speed is decreased temporarily, the risk of overturning in stepping down with the legs can be reduced. However, since an average speed is decreased, it is not preferable.

In the moving object 100 including the caster angle control unit 200, however, when disturbance is applied during the wheel driving, the directions of the casters can also be corrected without adding torque by controlling the caster angles. Therefore, by compensating for the disturbance applied to the leg tips or an influence of a manufacturing error, it is possible to realize stable driving. When the leg tips are shifted by disturbance during driving, compensation is realized by controlling the caster angles. Therefore, it is not particularly necessary to consider stepping-down or the like. The foregoing advantageous effects can be realized within the range of a normal control system without adding an actuator or adding a special mechanism or sensor.

When the caster angle control unit 200 is provided, it is not necessary to strongly perform the mechanical impedance control on the leg tips as in the comparison example to maintain the positions of the let tips with respect to the body. Therefore, disturbance is rarely delivered to the body, and thus an influence of the disturbance arising on the road surface on a motion of the moving object 100 is reduced. In addition to this advantageous effect, it is possible to reduce luggage applied to the links or the articulations binding the body to the leg tips and decrease strength or rigidity. Therefore, it is possible to reduce the weight of the links.

[Exemplary Operation of Control Unit]

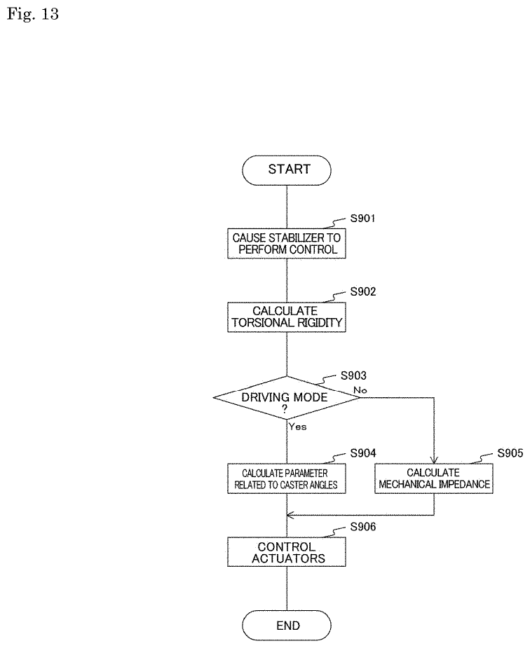

FIG. 13 is a flowchart illustrating an example of an operation of the control unit 180 according to the first embodiment of the present technology. This operation starts, for example, when a predetermined application for moving the moving object 100 is executed.

The control unit 180 causes the stabilizer 181 to perform the ZMP control (step S901) and calculate the torsional rigidity Kₜ (step S902). Then, the control unit 180 determines whether the present mode is the driving mode (step S903).

In the case of the driving mode (Yes in step S903), the control unit 180 calculates the parameter (p_{z}/pₓ, φ, or the like) related to the caster angle (step S104). Conversely, in the case of the walking mode (No in step S903), the control unit 180 calculates the mechanical impedance K₁ (step S905). After step S904 or S905, the control unit 180 controls the actuators based on the calculated value (step S906). After step S906, the control unit 180 ends the operation.

The control unit 180 may perform control such that the stability is ensured only for disturbance with a specific frequency bandwidth in consideration of not only stabilization characteristics of the relative position or posture of the leg tips but also dynamic characteristics of a tire expressed by the magic formula tire model or the like. For example, by constructing a control system in accordance with a loop shaping method, a desired frequency band can be designed to be suppressed. Specifically, immediately before step S906 in the drawing, the control unit 180 may adjust the calculated value of S904 or S905 when disturbance with a specific frequency bandwidth arises.

In this way, according to the first embodiment of the present technology, the control unit 180 controls the supporting legs based on the target value of the posture and the ZMP and controls the caster angles based on the target value. Therefore, it is possible to generate a road surface resistance force in accordance with the caster angles. Since the restoration moment is applied to the casters due to the road surface resistance force, it is possible to improve stability during the wheel driving.

### 2. Second Embodiment

In the above-described first embodiment, the moving object 100 changes its posture without assuming that luggage is carried. However, when the moving object 100 changes its posture while carrying luggage, there is concern of the luggage falling. The moving object 100 of a second embodiment is different from that of the first embodiment in that a luggage bed and lifts that horizontally maintain the luggage bed are further included.

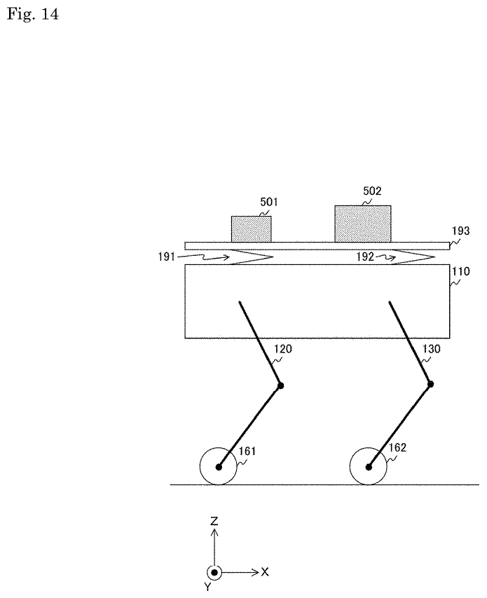

FIG. 14 is a side view illustrating an exemplary configuration of the moving object 100 according to the second embodiment of the present technology. The moving object 100 of the second embodiment is different from that of the first embodiment in that lifts 191 and 192 and a luggage bed 193 are further included.

The luggage bed 193 is a flat-shaped member on which luggage is put. The lifts 191 and 192 are members that support the luggage bed 193. The lift 191 is disposed in a front portion of the body 110 and the lift 192 is disposed in a rear portion. Each of the lifts 191 and 192 includes, for example, two links and an articulation connecting the links. This articulation can be rotated around a pitch axis by an actuator. The pitch angles of the articulations of the lifts 191 and 192 are controlled for stretching, so that the front and rear portions of the luggage bed 193 are independently raised and lowered.

The lifts 191 and 192 each include the links and the articulation, but the present technology is not limited to this configuration as long as the luggage bed can be raised and lowered. For example, one link that is stretched along the Z axis by an actuator can also be used as the lifts 191 and 192.

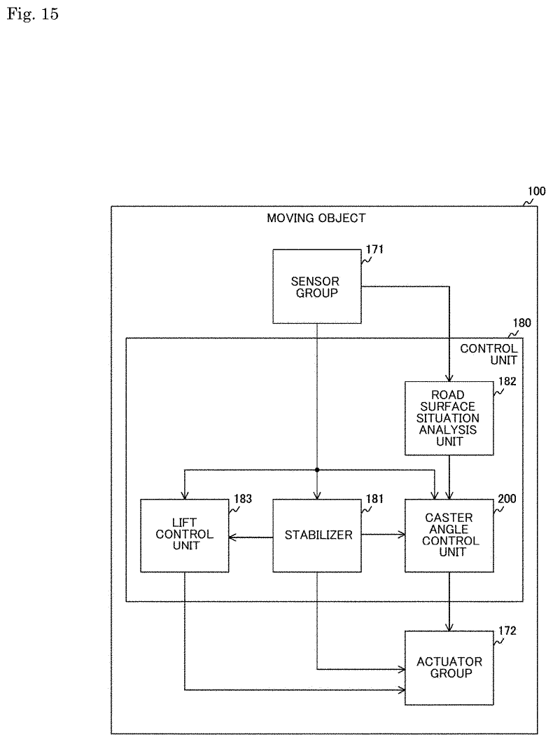

FIG. 15 is a block diagram illustrating an exemplary configuration of the moving object 100 according to the second embodiment of the present technology. The moving object 100 of the second embodiment is different from that of the first embodiment in that a lift control unit 183 is further included in the control unit 180.

The stabilizer 181 according to the second embodiment also supplies posture information to the lift control unit 183. The sensor group 171 according to the second embodiment further includes a sensor that detects an angle of each of the lifts 191 and 192, and sensor data is supplied to the lift control unit 183. The actuator group 172 according to the second embodiment further includes an actuator that drives an articulation of each of the lifts 191 and 192.

The lift control unit 183 controls the lifts 191 and 192 based on a posture indicated by the posture information such that the luggage bed 193 remains horizontal. When a pitch angle of the body 110 is greater than “0” degrees, the lift control unit 183 causes the height of one of the lifts 191 and 192 to be higher than the height of the other lift by controlling the actuators in accordance with this angle.

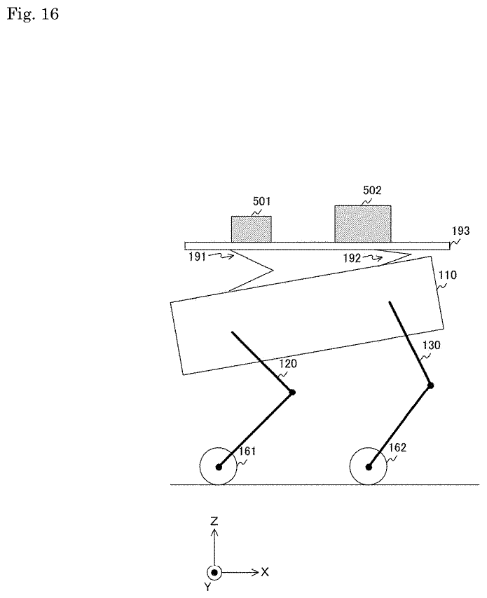

FIG. 16 is a diagram illustrating a method of controlling the lifts 191 and 192 according to the second embodiment of the present technology. As exemplified in the drawing, when the height of the front portion of the body 110 is lower than the height of the rear portion, the lift control unit 183 expands the front lift 191 and contracts the rear lift 192. Thus, it is possible to cause the luggage bed 193 to remain horizontal so that luggage can be prevented from falling.

When the height of the front portion of the body 110 is higher than the height of the rear portion, the lift control unit 183 may contract the front lift 191 and expand the rear lift 192.

In this way, according to the second embodiment of the present technology, the lift control unit 183 controls the lifts 191 and 192 based on the posture. Therefore, when the posture is changed, the luggage bed 193 can also remain horizontal, and thus it is possible to prevent the luggage bed from falling.

### 3. Third Embodiment

In the above-described first embodiment, the body 110 is configured by one member, but the body 110 can also be separated into two pieces. The moving object 100 of a third embodiment is different from that of the first embodiment in that the body is separated into two pieces.

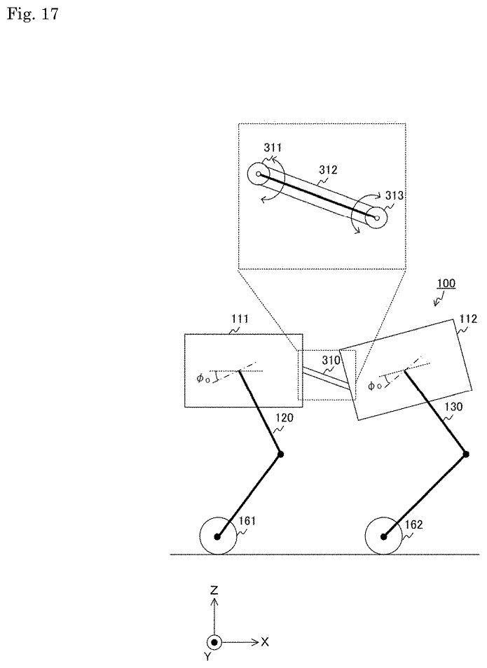

FIG. 17 is a side view illustrating an exemplary configuration of a moving object 100 according to the third embodiment of the present technology. The moving object 100 of the third embodiment is different from that of the first embodiment in that the body 110 includes a front body 111, a rear body 112, and a connection unit 310.

The front body 111 is a member on which the supporting legs 120 and 140 are mounted and is provided on the front side of the moving object 100. The rear body 112 is a member on which the supporting legs 130 and 150 are mounted and is provided on the rear side of the moving object 100.

The connection unit 310 connects the front body 111 to the rear body 112. The connection unit 310 includes a front articulation 311, a link 312, and a rear articulation 313.

The front articulation 311 is an articulation connecting the front body 111 to the link 312 and can be pivoted around the pitch axis by the actuator. The rear articulation 313 is an articulation connecting the rear body 112 to the link 312 and can be pivoted around the pitch axis by the actuator. The link 312 is a member that connects the front articulation 311 to the rear body 112.

In the above-described configuration, the control unit 180 can independently control a posture of the front body 111 and a posture of the rear body 112. Thus, when the posture of one of the front body 111 and the rear body 112 is slightly changed, the change does not considerably influence the posture of the other body. Therefore, it is possible to further improve stability of the entire moving object 100.

In this way, according to the third embodiment of the present technology, the control unit 180 independently controls the posture of each of the front body 111 and the rear body 112. Therefore, it is possible to further improve stability of the entire moving object 100.

### 4. Fourth Embodiment

In the above-described third embodiment, the moving object 100 changes its posture without assuming that luggage is carried. However, when the moving object 100 changes its posture while carrying luggage, there is concern of the luggage falling. The moving object 100 of the fourth embodiment is different from that of the third embodiment in that a luggage bed and a lift that horizontally maintains the luggage bed are further included.

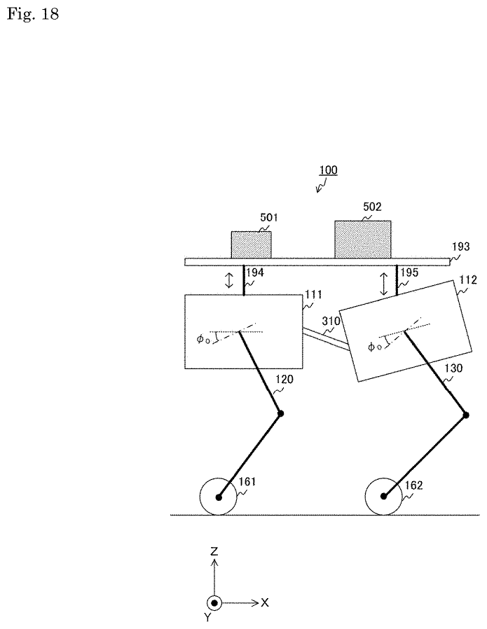

FIG. 18 is a side view illustrating an exemplary configuration of the moving object 100 according to the fourth embodiment of the present technology. The moving object 100 according to the fourth embodiment is different from that of the third embodiment in which lifts 194 and 195 and a luggage bed 193 are further included. The lifts 194 and 195 support the luggage bed 193 and are configured by one link stretched in the Z direction.

The configuration of the control unit 180 of the fourth embodiment is the same as that of the second embodiment.

In this way, according to the fourth embodiment of the present technology, the lift control unit 183 controls the lifts 191 and 192 based on a posture. Therefore, when the posture is changed, the luggage bed 193 remains horizontal, and thus it is possible to prevent the luggage bed from falling.

### 5. Fifth Embodiment

In the above-described first embodiment, in the moving object 100, the caster angles in the initial state are set to be the same between the front and the rear by causing the mounting angle of the front supporting legs 120 and 140 to be the same as the mounting angle of the rear supporting legs 130 and 150. However, the larger the caster angle is, the larger a minimum turning radius is. Therefore, to facilitate turning, in particular, the caster angle of the front supporting legs is preferably less than those of the rear supporting legs. A fifth embodiment is different from the first embodiment in that the mounting angle of the front supporting legs 120 and 140 is different from the mounting angle of the rear supporting legs 130 and 150.

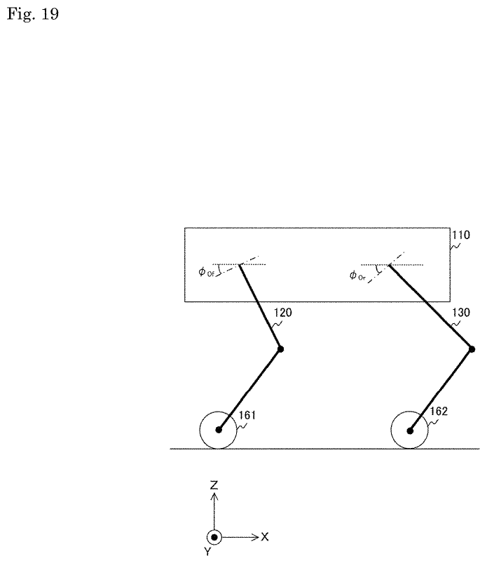

FIG. 19 is a side view illustrating an exemplary configuration of the moving object 100 according to the fifth embodiment of the present technology. The moving object 100 of the fifth embodiment is different from that of the first embodiment in that a mounting angle φ_{0f} of the front supporting legs 120 and 140 is different from a mounting angle φ₀ᵣ of the rear supporting legs 130 and 150. For example, the front mounting angle φ_{0f} is set to a smaller value than the rear mounting angle φ₀ᵣ. Thus, in the initial state, the front caster angle can be less than the rear caster angle. Accordingly, when the front mounting angle is the same as the rear mounting angle, the moving object 100 easily turns.

Straight movement stability of the front supporting legs 120 and 140 can be preferred to the rear by setting the front mounting angle φ_{0f} to be greater than the rear mounting angle φ₀ᵣ. In this way, by changing the front and rear mounting angles, it is possible to tune spin characteristics or straightness when disturbance occurs.

Each of the first to fourth embodiments can be applied to the fifth embodiment.

In this way, according to the fifth embodiment of the present technology, the mounting angle of the front supporting legs 120 and 140 is different from the mounting angle of the rear supporting legs 130 and 150. Therefore, in the initial state, the caster angle can be set to be different between the front and rear sides.

### 6. Sixth Embodiment

In the above-described first embodiment, the control unit 180 controls the caster angle to improve the stability of the moving object 100. However, when an unevenness or a stepped difference on a road surface is equal to or greater than an assumed unevenness or stepped difference, there is concern of a posture being changed. The moving object 100 of a sixth embodiment is different from that of the first embodiment in that a damper is provided in the caster to improve stability.

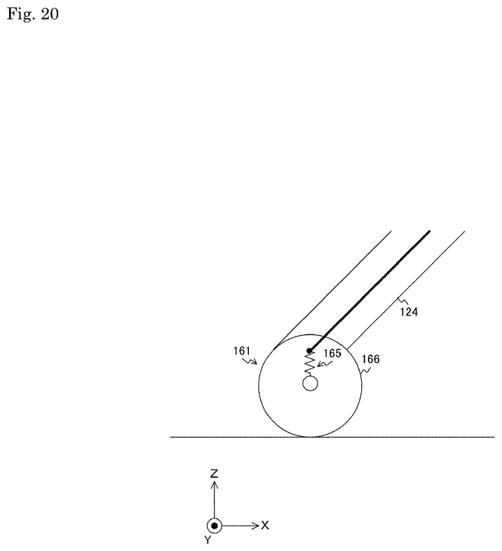

FIG. 20 is a cross-sectional view illustrating an exemplary configuration of the caster 161 according to the sixth embodiment of the present technology. The caster 161 according to the sixth embodiment includes a wheel unit 166 and a damper 165.

The wheel unit 166 is a circular component mounted on an axle. The damper 165 is a component stretched in the Z direction perpendicular to a road surface. The damper 165 is provided between the axle and the distal end of the link 124. For example, as elastic body (a spring, an oil damper, or the like) is used as the damper 165.

A configuration of each of the casters 162 to 164 is the same as that of the caster 161.

The damper 165 is contracted in accordance with a live load, an aerodynamic weight, or the like, and thus the caster trail is enlarged and the caster angle is increased. Thus, when an unevenness or a stepped difference is got over, it is possible to improve straight movement stability of the moving object 100.

Each of the first to fourth embodiments can be applied to the sixth embodiment.

In this way, according to the sixth embodiment of the present technology, the damper 165 is stretched. Therefore, by enlarging the caster angle in accordance with a weight, it is possible to improve the stability of the moving object 100.

### 7. Seventh Embodiment

In the above-described first embodiment, the supporting leg 120 and the like include the first articulation 121 pivoting about only one axis (the roll axis). In this configuration, there is concern of a movable range of the first articulation not being sufficiently ensured. The moving object 100 of a seventh embodiment is different from that of the first embodiment in that the first articulation pivoting about two axes is provided to broaden the movable range.

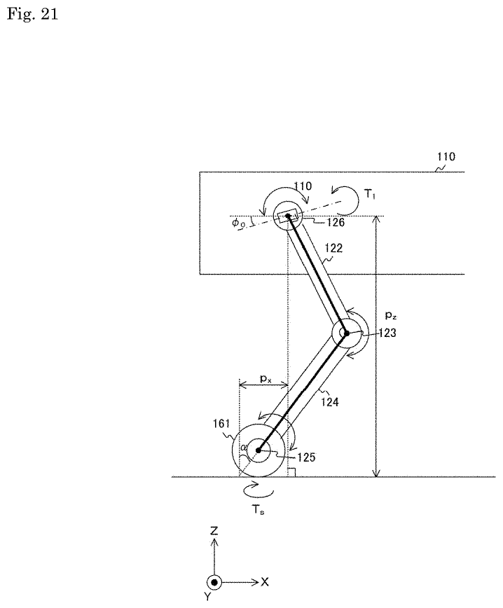

FIG. 21 is a side view illustrating an exemplary configuration of the moving object 100 according to the seventh embodiment of the present technology. The moving object 100 of the seventh embodiment is different from that of the first embodiment in that a first articulation 126 is provided in the supporting leg 120 instead of the first articulation 121.

The first articulation 126 is a biaxial articulation pivoted about two axes (the roll axis and the pitch axis). Each of the supporting legs 130, 140, and 150 also includes a biaxial first articulation as in the supporting leg 120.

When the first articulation 126 is the biaxial articulation, the first articulation 121 can broaden the movable range of the supporting leg 120 compared to the uniaxial articulation of the first embodiment.

Each of the first to sixth embodiments can be applied to the seventh embodiment.

In this way, according to the seventh embodiment of the present technology, the biaxal first articulation 126 is provided. Therefore, it is possible to broaden the movable range of the supporting leg more than when the uniaxial first articulation is provided.

### 8. Eighth Embodiment

In the above-described first embodiment, four supporting legs are mounted on the body 110. However, the larger the number of supporting legs is, the larger the number of components is. Thus, there is concern of manufacturing cost of the moving object 100 increasing. The larger the number of supporting legs is, the larger the area of the supporting polygon is. Thus, there is concern of movement to a narrow place being difficult. The moving object 100 of an eighth embodiment is different from that of the first embodiment in that the number of supporting legs is reduced to two.

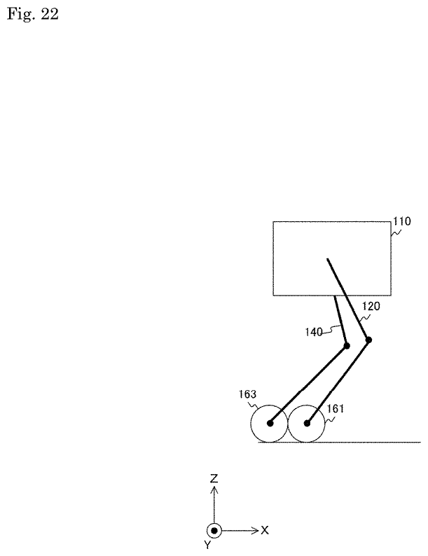

FIG. 22 is a side view illustrating an exemplary configuration of the moving object 100 according to the eighth embodiment of the present technology. The moving object 100 of the eighth embodiment is different from that of the first embodiment in that the supporting legs 120 and 140 are mounted on the body 110.

As exemplified in the drawing, two supporting legs are provided. Thus, the manufacturing cost is further reduced and movement to a narrow place is easier than when four legs are provided.

The sixth or seventh embodiment can be applied to the eighth embodiment.

In this way, in the eighth embodiment of the present technology, two supporting legs are provided. Thus, the manufacturing cost is further reduced and movement to a narrow place is easier than when four legs are provided.

The above-described embodiments have been described as examples for realizing the present technology and matters in the embodiments and inventive specific matters in the clams have correspondence relations. Similarly, the inventive specific matters in the claims and matters of the embodiments of the present technology to which the same names are given have correspondence relations. Here, the present technology is not limited to the embodiments and various modifications of the embodiments can be made within the scope of the present technology without departing from the gist of the present technology.

The processing procedures in the above-described embodiments may be ascertained as methods including the series of procedures or may be ascertained as a program that causes a computer to perform the series of procedures or a recording medium that stores the program. As the recording medium, for example, a compact disc (CD), a mini-disc (MD), a digital versatile disc (DVD), a memory card, a Blu-ray (registered trademark) disc, or the like can be used.

The advantageous effects described in the present specification are merely exemplary and are not limitative, and other advantageous effects can be achieved.

The present technology can be configured as follows.

(1) A moving object including:

a plurality of supporting legs in which bases are mounted on a body and casters are mounted on distal ends;

a stabilizer configured to control a position in contact with the ground of the caster of each of the plurality of supporting legs based on a target value of a posture of the body; and

a caster angle control unit configured to control a caster angle of each of the casters based on the target value.

(2) The moving object according to (1), wherein, in transition to a driving mode in which the moving object performs wheel driving, the caster angle control unit obtains a ratio of a height from a road surface to the base to a caster trail of the caster and a new target value based on a mechanical impedance and torsional rigidity of each of the plurality of supporting legs.

(3) The moving object according to (1) or (2), wherein, in transition to a walking mode in which the moving object performs walking, the caster angle control unit obtains a mechanical impedance based on torsional rigidity of each of the plurality of supporting legs, the target value, a height from a road surface to the base, and a caster trail of the caster.

(4) The moving object according to any one of (1) to (3), further comprising: a plurality of lifts configured to support a luggage bed; and

a lift control unit configured to control the plurality of lifts based on the target value.

(5) The moving object according to any one of (1) to (4), wherein the body includes a front body, a rear body, and a connection unit connecting the front body to the rear body.

(6) The moving object according to any one of (1) to (5), wherein the caster includes a wheel unit and a damper stretched in a direction perpendicular to the road surface.

(7) The moving object according to any one of (1) to (6), wherein each of the plurality of supporting legs includes a first articulation provided in the base, a second articulation, and a third articulation provided in the distal end, and

the first articulation is a biaxial articulation.

(8) The moving object according to any one of (1) to (7), wherein the plurality of supporting legs include a pair of front supporting legs and a pair of rear supporting legs.

(9) The moving object according to (8), wherein a mounting angle of the base of each of the pair of front supporting legs is different from a mounting angle of the base of each of the pair of rear supporting legs.

(10) The moving object according to any one of (1) to (7), wherein the number of plurality of supporting legs is two.

(11) A method of controlling a moving object, the method comprising:

a stabilization procedure of controlling a position in contact with the ground of a caster of each of a plurality of supporting legs in which bases are mounted on a body and the casters are mounted on distal ends, based on a target value of a posture of the body; and

a caster angle control procedure of controlling a caster angle of each of the casters based on the target value.

### REFERENCE SIGNS LIST

100 Moving object

110 Body

111 Front body

112 Rear body

120, 130, 140, 150 Supporting leg

121, 126 First articulation

122, 124, 312 Link

123 Second articulation

125 Third articulation

161 to 164 Caster

165 Damper

166 Wheel unit

171 Sensor group

172 Actuator group

180 Control unit

181 Stabilizer

182 Road surface situation analysis unit

183 Lift control unit

191, 192, 194, 195 Lift

193 Luggage bed

200 Caster angle control unit

210 Respective posture-based torsional rigidity map

220 Torsional rigidity acquisition unit

230 Walking mode control unit

231, 241 Parameter calculation unit

232, 242 Mechanical impedance calculation unit

233, 243 Actuator control unit

240 Driving mode control unit

250 Selection unit

310 Connection unit

311 Front articulation

313 Rear articulation

1. A moving object comprising:
a plurality of supporting legs in which bases are mounted on a body and casters are mounted on distal ends;
a stabilizer configured to control a position in contact with the ground of the caster of each of the plurality of supporting legs based on a target value of a posture of the body; and
a caster angle control unit configured to control a caster angle of each of the casters based on the target value.

2. The moving object according to claim 1, wherein, in transition to a driving mode in which the moving object performs wheel driving, the caster angle control unit obtains a ratio of a height from a road surface to the base to a caster trail of the caster and a new target value based on a mechanical impedance and torsional rigidity of each of the plurality of supporting legs.

3. The moving object according to claim 1, wherein, in transition to a walking mode in which the moving object performs walking, the caster angle control unit obtains a mechanical impedance based on torsional rigidity of each of the plurality of supporting legs, the target value, a height from a road surface to the base, and a caster trail of the caster.

4. The moving object according to claim 1, further comprising:
a plurality of lifts configured to support a luggage bed; and
a lift control unit configured to control the plurality of lifts based on the target value.

5. The moving object according to claim 1, wherein the body includes a front body, a rear body, and a connection unit connecting the front body to the rear body.

6. The moving object according to claim 1, wherein the caster includes a wheel unit and a damper stretched in a direction perpendicular to the road surface.

7. The moving object according to claim 1,
wherein each of the plurality of supporting legs includes a first articulation provided in the base, a second articulation, and a third articulation provided in the distal end, and
wherein the first articulation is a biaxial articulation.

8. The moving object according to claim 1, wherein the plurality of supporting legs include a pair of front supporting legs and a pair of rear supporting legs.

9. The moving object according to claim 8, wherein a mounting angle of the base of each of the pair of front supporting legs is different from a mounting angle of the base of each of the pair of rear supporting legs.

10. The moving object according to claim 1, wherein the number of plurality of supporting legs is two.

11. A method of controlling a moving object, the method comprising:
a stabilization procedure of controlling a position in contact with the ground of a caster of each of a plurality of supporting legs in which bases are mounted on a body and the casters are mounted on distal ends, based on a target value of a posture of the body; and
a caster angle control procedure of controlling a caster angle of each of the casters based on the target value.
